(19) United States
(12) Patent Application Publication
(10) Pub. No.: US 2012/0317003 A1
(43) Pub. Date: Dec. 13, 2012

(54) AUTOMATED EXPENSE ACCOUNT REPORT GENERATOR

(76) Inventor: Russell McGrane, Highlands Ranch, CO (US)

(21) Appl. No.: 13/492,453

(22) Filed: Jun. 8, 2012

Related U.S. Application Data
(60) Provisional application No. 61/495,146, filed on Jun. 9, 2011.

(51) Int. Cl. G06Q 40/00

(52) U.S. Cl. 705/30

(57) ABSTRACT

An automated expense account report generator. Upon occurrence of a purchase transaction initiated using a transaction card by a user, the automated expense account report generator initiates transmission of a communication (e.g., a text message) to the user. The user responds to the communication (e.g., via text message) to provide transaction data corresponding to the purchase transaction. The transaction data is automatically processed to create an expense account entry in an expense account report including the transaction data provided by the user.

### RELATED APPLICATIONS

This application claims priority to U.S. Provisional Patent Application No. 61/495,146 filed Jun. 9, 2011, entitled “AUTOMATED EXPENSE ACCOUNT REPORT GENERATOR,” which application is incorporated herein by reference in its entirety.

### FIELD OF THE INVENTION

The present invention relates to automated generation of an expense account report and specifically to the automatic generation of an expense account report including transaction data relating to a purchase transaction initiated using a transaction card, wherein at least a portion of the transaction data is received via a reply from a user in response to a communication initiated based on the purchase transaction.

### BACKGROUND OF THE INVENTION

Many individuals are allowed the use of an expense account for business transactions or the like. Such expense accounts may be provided by an expense account report provider (e.g., an employer, contractor, etc.). The expense account may be used for business related expenses such that details regarding the expenses are tracked (e.g., for reimbursement or other accounting purposes). In many instances, a user of the expense account must provide an expense account report to provide details regarding the nature of the purchase transactions made using the expense account.

Such expense account reports are often prepared by the user. The preparation and submission of expense account reports may require a substantial amount of the user's time to prepare. Preparation of expense account reports may require retaining receipts or providing other information regarding the nature of purchase transactions. Not only may this present a frustrating, time consuming experience to the user, but may also occupy the time of each user of an expense account that could otherwise be dedicated to other business functions, thus detracting from productivity on a potentially large scale.

Furthermore, such expense account reports are often due at regular intervals (e.g., monthly, quarterly, biannually, etc.). In this regard, there may be a delay between the occurrence of a transaction and the preparation of the expense account report. During this delay, the user may forget transactions altogether, forget the nature of the transaction, lose receipts, etc. This introduces the potential for omission of purchase transactions, mistakes regarding reporting of the nature of the purchase transaction, or other mistakes that detract from the accuracy of the expense account report.

### SUMMARY OF THE INVENTION

In view of the foregoing, one objective of the present invention is to reduce the administrative burden associated with preparation of expense account reports. Another objective of the present invention is to improve the accuracy of data included in expense account reports. Yet another objective is to provide a user friendly interface that is accessible at the time of or near the time of a purchase transaction.

Accordingly, inventive systems and methods are provided for automatic generation of an expense account report for purchases initiated using a transaction card. The systems and methods may employ a substantially real-time communication modality (e.g., text messaging via a cellular network) to collect transaction data regarding a purchase transaction from a user at the time of the purchase transaction or soon thereafter. At least a portion of the user-originated transaction data is used to automatically generate an expense account report entry associated with the purchase transaction. Thus, an expense account report is automatically generated that includes the transaction data received from the user.

A first aspect of the present invention includes a method for automatic generation of an expense account report. Upon detecting the occurrence of a purchase transaction initiated using a transaction card by a user, transmission of at least one automatically generated text message to a mobile device associated with the user is initiated. The automatically generated text message includes a request for transaction data corresponding to the purchase transaction. The method further includes receiving a response text message initiated at the mobile device in response to the automatically generated text message including the transaction data (i.e., user-originated transaction data). The response text message is processed to automatically generate an expense account entry of an expense account report such that the expense account entry includes the transaction data contained in the response text message.

A number of feature refinements and additional features are applicable to the first aspect. These feature refinements and additional features may be used individually or in any combination. As such, each of the following features that will be discussed may be, but are not required to be, used with any other feature or combination of features of the first aspect.

In one embodiment, each step of the method of the first aspect is automatically performed by one or more automated logic devices. As such, the method of the first aspect may be completely autonomous and executed without intervention by a human operator.

The expense account report may include a plurality of expense account report entries. Each expense account report entry may correspond to a purchase transaction initiated using the transaction card. The expense account report may include expense account report entries for purchase transactions initiated during a predetermined time period. In one embodiment, the expense account report includes an expense account report entry for every purchase transaction initiated using the transaction card during the predetermined time period.

In one embodiment, the expense account report may be maintained in a computer readable medium for review by a user. In this regard, the expense account report may be stored in any appropriate computer readable form including, for example, as a spreadsheet, as a database, or as an XML document. The method of the first aspect may include providing access to the expense account report by the user. This access may be secured such that obtaining access to the expense account report requires the user to provide proprietary card data associated with the transaction card. Examples of such proprietary card data include a user name, a password, a personal identification number, a card number, and a billing address.

In another embodiment, the expense account report is transmitted to the user (e.g., at regular intervals corresponding to the predetermined time period). Accordingly, the expense account report may be transmitted to the user along with a billing statement associated with the transaction card. The predetermined time period may coincide with the billing statement time period. The billing statement and/or expense account report may be provided electronically or in hard copy form.

In yet another embodiment, the expense account report is automatically transmitted to an expense account provider. For example, the expense account provider may have an expense account reporting system. The expense account report may be provided directly to the expense account reporting system such that the expense account report directly interfaces with the expense account reporting system.

In one embodiment, the transaction data received from the user may include data selected from the group consisting of: third party identification data, customer identification data, client identification data, expense code data, notes, project identification data, accounting data (e.g., general ledger data, etc.), or other appropriate data corresponding to the transaction. Additionally, the expense account report may include one or more predetermined information fields. The predetermined information fields may correspond to respective portions of the transaction data received from the user. As such, the portions of transaction data may be separated by a delineator. This delineator may be used to parse the different portions of transaction data for inclusion in a respective one of the predetermined information fields.

In another embodiment, the method of the first aspect may include processing the purchase transaction. This processing may include reconciling the purchase transaction, debiting an associated account, correlating the purchase transaction to a corresponding account in a billing system, or other appropriate action taken by a financial institution upon the occurrence of a purchase transaction using a transaction card. The processing may include use of at least some merchant-originated transaction data. At least a portion of the merchant-originated transaction data may also be included in the automatically generated text message. This may assist the user in identifying the purchase transaction that is the subject of the automatically generated text message.

A second aspect includes a system for automatic generation of an expense account report. The system includes a merchant interface module, a communication module, an automatic expense account report entry generator, and an expense account report. The merchant interface module is operable to detect a purchase transaction initiated by a user using a transaction card. The communication module is in operative communication with the merchant interface module such that upon detection of the purchase transaction, the communication module initiates transmission of an automatically generated text message to a mobile device associated with the user. The communication module may also receive a response text message to the automatically generated text message that includes transaction data. Accordingly, the communication module may be in operative communication with a cellular network for delivery and receipt of the text messages. The automatic expense account report entry generator may process the response text message and automatically generate an expense account report entry that includes at least a portion of the transaction data. The expense account report entry is included in the expense account report.

A number of feature refinements and additional features are applicable to the second aspect. These feature refinements and additional features may be used individually or in any combination. As such, each of the following features that will be discussed may be, but are not required to be, used with any other feature or combination of features of the second aspect.

In one embodiment, the transaction card used in the purchase transaction is a dedicated transaction card. As such, the transaction card may be designated for use only in expense account purchase transactions. In this regard, an expense account report entry may be generated for each purchase transaction initiated using the transaction card.

In another embodiment, the merchant interface module may be operable to receive at least a portion of merchant-originated transaction data. This merchant-originated transaction data may be transmitted by the merchant upon the initiation of the purchase transaction. For example, the merchant-originated data may be sent directly to a financial institution. This merchant-originated transaction data may include data used for the processing of the purchase transaction by the financial institution. In this regard, the system may also include a transaction processor that processes the transaction in a manner described above with respect to the first aspect. At least a portion of the merchant-originated transaction data may also be included in the automatically generated text message. This may assist a user in identifying the purchase transaction that is the subject of the automatically generated text message.

The communication module may have access to a memory that includes a mobile device number for the mobile device of the user. This memory may be maintained by the financial institution (e.g., in a database including user information or proprietary card data).

The response text message may include a number of portions of transaction data. As such, the response text message may include portions of transaction data separated by a delineator (e.g., a delineating character). The expense account report may include a plurality of predetermined information fields corresponding to different ones of the portions of transaction data. In this regard, the automatic expense account report entry generator may parse the response text message to populate respective ones of the predetermined information fields with appropriate portions of transaction data contained in the response text message.

In another embodiment, the expense account report may be maintained in a computer readable medium for review by the user. The user may access the expense account report (e.g., by way of a web based interface or the like). This access to the expense account report may be secured such that proprietary card data is supplied in order to gain access to the expense account report.

The expense account report may include a plurality of expense account report entries corresponding to respective purchase transactions. For instance, the expense account report may include expense account report entries for each purchase transaction initiated using the transaction card for a predetermined period. This predetermined period may coincide with a billing statement period for the transaction card.

In yet another embodiment, the communication module may receive a response text message indicating the purchase transaction associated with the automatically generated text message was not authorized. In this regard, the user may provide information to indicate a purchase transaction is fraudulent or otherwise unauthorized at the time of the transaction or soon thereafter. This may provide an additional security feature for the transaction card.

In another embodiment, a user may respond to an automatically generated text message with an indicator that the purchase transaction corresponding to the automatically generated text message was a personal transaction. Personal transactions may be excluded from the expense account report or may be otherwise processed to account for the personal nature of the transaction.

In still another embodiment, the system of the second aspect may be operable to record transaction data for purchase transactions or other expenses occurred where the transaction card is not used. In this regard, the communication module may be operable to receive inbound text messages. These inbound text messages may be in a format that is parsable by the automatic expense account report entry generator to create an expense account report entry based on the transaction data provided in the inbound text message even though no purchase transaction using the transaction card is detected. Such inbound text messages may be used to document expenses such as, for example, mileage, tolls, cash expenditures, or other expenses not incurred via the transaction card.

Numerous additional features and advantages of the present invention will become apparent to those skilled in the art upon consideration of the embodiment descriptions provided hereinbelow.

### BRIEF DESCRIPTION OF THE DRAWINGS

FIG. 1 is a schematic view of an embodiment of a system for automatic generation of an expense account report.

FIG. 2 is a detailed schematic view of an embodiment of a system for automatic generation of an expense account report.

FIG. 3 is a screen shot of an embodiment of an automatically generated text message received at a mobile device associated with a user as displayed on the mobile device.

FIG. 4 is a screen shot of an embodiment of a response text message initiated at a mobile device associated with a user as displayed on the mobile device.

FIG. 5 is an embodiment of a portion of an expense account report including an expense account entry automatically generated from the response text message of FIG. 4.

### DETAILED DESCRIPTION

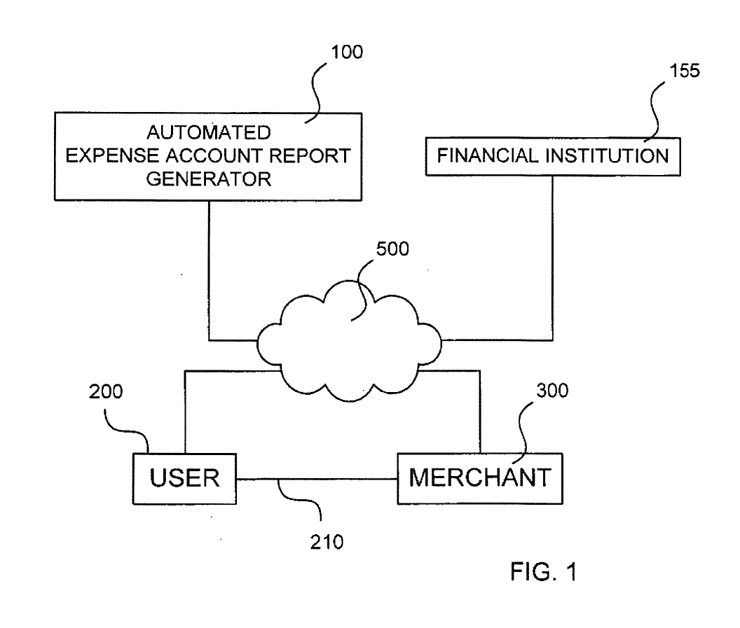

The present invention is generally related to the automated generation of an expense account report based on communication with a user initiated in response to a purchase transaction using a transaction card. As shown in FIG. 1, a user 200 initiates a purchase transaction 210 at a merchant 300 using a transaction card. The transaction card may be a prepaid transaction card, a credit card, a debit card, or any other appropriate type of transaction card that may be used for value at the merchant 300.

Upon initiation of the purchase transaction 210, the merchant 300 may communicate transaction data regarding the purchase transaction to an automated expense account report generator 100. The communication may be passed via a communication network 500. While a single cloud is shown in FIG. 1 to represent the communication network 500, a number of different networks may be provided for communication between the various entities depicted in FIG. 1. Accordingly, the communication network 500 may include a switched public telephone network, a cellular communication network, a wide area network such as the Internet, other appropriate communication networks, or a combination thereof. Accordingly, different ones of these communication network types may be used to facilitated communication between entities as will be further discussed below.

In one embodiment, the merchant 300 communicates merchant-originated transaction data to a financial institution 155 (e.g., an issuer or processor of the transaction card). The financial institution 155 may then provide some or all of the merchant-originated transaction data to the automated expense account report generator 100. The automated expense account report generator 100 may be operated by the financial institution 155 or may be operated by a third party service provider that interfaces with the financial institution 155 (e.g., by way of communication network 500).

In any regard, receipt of transaction data at the automated expense account report generator 100 may indicate the occurrence of the purchase transaction 210 initiated using the transaction card. In response, the automated expense. account report generator 100 may initiate a communication with the user 200 in order to solicit transaction data (i.e., user-originated transaction data) from the user 200 related to the purchase transaction 210 for inclusion in an expense account report. The communication between the user 200 and the automated expense account report generator 100 may be by way of the communication network 500. In one embodiment, the communication between the automated expense account report generator 100 and the user 200 may be by way of text messages (e.g., exchanged via a cellular telephone network). Note the communication network 500 used to communicate between the automated expense account report generator 100 and user 200 may be the same or different network used to facilitate communication between the merchant 300 and the automated expense account report generator 100.

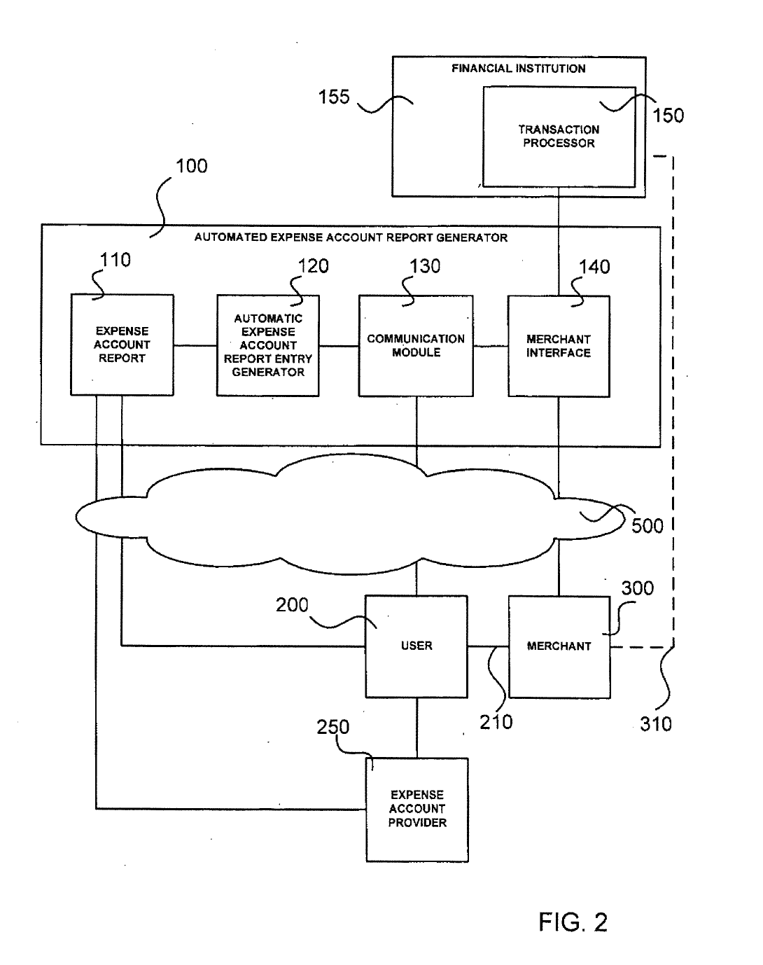

FIG. 2 shows a more detailed schematic view of an automated expense account report generator 100. Like reference numerals will be used throughout this description and the figures to describe common elements. As shown in FIG. 2 and mentioned above with regard to FIG. 1, the user 200 may initiate a purchase transaction 210 at a merchant 300 using a transaction card. The merchant 300 may communicate with a merchant interface 140 of the automated expense account report generator 100 (e.g., by way of communication network 500). Again, while a single cloud is used in FIG. 2 to represent communication network 500, communication network 500 may include one or more different communication networks as described above with respect to FIG. 1.

In one embodiment, the automated expense account report generator 100 may be associated with a financial institution 155 that issues the transaction card or processes transactions using the transaction card. Accordingly, the communication from the merchant 300 to the automated expense account report generator 100 may be of the type normally utilized in processing the purchase transaction at a financial institution 155 including, for example, merchant identification information, transaction amount information, authorization request information, or the like. These merchant-originated transaction details may be communicated to a transaction processor 150 as shown in FIG. 2 for processing of the purchase transaction (e.g., reconciling the transaction, debiting an associated account, correlating the purchase transaction to a corresponding account in a billing system, etc.). In an alternative embodiment, a financial institution 155 including the transaction processor 150 may act as an intermediary between the merchant 300 and the automated expense account report generator 100 such that the merchant-originated transaction details provided by the merchant 300 directly to the financial institution 155 (e.g., as shown by dotted line 310). The financial institution 155 may relay at least a portion of the merchant-originated transaction data to the merchant interface 140 of the automated expense account report generator 100.

In any regard, the receipt of transaction data at the merchant interface 140 may indicate the occurrence of the purchase transaction 210. Once the merchant-originated transaction data is received at the automated expense account report generator 100, the transaction data may be passed to a communication module 130. The communication module 130 may initiate transmission of an automatically generated text message to the user 200. For example, the automatically generated text message may be sent to a mobile device of the user 200 associated with the user. In this regard, a mobile device number may be associated with the user 200. The communication module 130 may include a memory for storing card data including the mobile device number associated with the user 200. Alternatively or additionally, the communication module 130 may have access to a memory or database storing such card data including the mobile device number of the user 200. For example, the database may be maintained at the financial institution 155.

The automatically generated text message sent to the user 200 may include at least a portion of the merchant-originated transaction data. The merchant-originated transaction data may help the user 200 identify the purchase transaction 210 that is the subject of the automatically generated text message. Also, the automatically generated text message may include other data such as the date of the transaction.

In one embodiment, if the purchase transaction 210 was not authorized by the user 200, the user 200 may respond to the automatically generated text message with a response indicating the purchase transaction 210 was not authorized. This may provide an additional security feature that allows for detection of unauthorized purchases as will be discussed further below. Additionally, the user may be able to respond to the automatically generated text message with an indication that the purchase transaction was a personal transaction to be excluded from the expense report as will be discussed further below.

The automatically generated text message may also include a request for additional transaction data corresponding to the purchase transaction 210. This user-originated transaction data is related to the purchase transaction and may include, for example, data selected from the user-originated data group consisting of:
third party identification data;
customer identification data;
client identification data;
expense code data;
notes;
project identification data;
accounting data (e.g., general ledger data, etc.); or
other appropriate data corresponding to the transaction.

The user 200, in response to the automatically generated text message, sends a response text message to the communication module 130 that includes transaction data (e.g., corresponding to the data that was requested in the automatically generated text message). The communications module 130 may pass the response text message to an automatic expense account report entry generator 120. The automatic expense account report entry generator 120 may process the response text message to extract the transaction data (e.g., including merchant-originated transaction data and/or user-originated transaction data) contained therein to automatically generate an expense account entry in an expense account report 110. In this regard, the expense account report 110 may include the expense account entry including merchant-originated transaction data provided by the merchant 300 as well as user-originated transaction data provided by the user 200.

It will be appreciated that the nature of the above described automated expense account report generator 100 may allow for substantially “real time” communication with the user 200. That is, the user may receive the automatically generated text message at the time of the purchase transaction 210 or very soon thereafter. In this regard, the nature of the purchase transaction may still be fresh in the mind of the user 200 when the user 200 receives the automatically generated text message. Accordingly, the above described system may allow a user 200 to prepare an “on-the-fly” expense account report rather than attempting to remember or reconstruct the context and transaction data for a purchase transaction 210 some time after the occurrence of the transaction.

The expense account report 110 may be maintained in a computer readable medium for review by the user 200. For example, as shown in FIG. 2, the user 200 may access the expense account report 110. For example, an online interface such as a website or the like may be provided such that the user 200 may access the expense account report 110 by way of a communication network 500 (e.g., the Internet). Access to the expense account report 110 may be by way of a secure interface such that proprietary card data associated with the transaction card (e.g., a user name, password, personal identification number (PIN), card number, billing address, etc.) must be provided by the user 200 in order to access the expense account report 110.

Alternatively or additionally, the expense account report 110 may be sent directly to the user 200. The expense account report 110 may be sent to the user 200 in an electronic form such that the expense account report 110 is maintained in a computer readable format. For example, the expense account report 110 may be sent to the user 200 by way of an electronic communication modality such as e-mail or the like (e.g., via the communication network 500). Note that the communication modality used to send the user 200 the expense account report 110 may the same modality used to communicate with the user 200 to collect transaction data or may be a different communication modality.

The expense account report 110 may reflect any or all purchase transactions 210 initiated by the user 200 using the transaction card in a predetermined time period. The predetermined time period may coincide with a billing statement period of the transaction card. In this regard, the expense account report 110 may be communicated to the user 200 in conjunction with a billing statement for the transaction card covering the predetermined time period. For example, the billing statement and expense account report 110 may communicated to the user together electronically or in a traditional hardcopy form.

The user 200 may employ the expense account report 110 accessed or received from the automated expense account report generator 100 to provide an expense account report to an expense account provider 250. In this regard, the expense account report 110 may be in a format appropriate for direct submission to the expense account provider 250 after review by the user 200. That is, the expense account report 110 may be provided to the user 200 in a form that, once reviewed, is directly submitted to an expense account reporting system of an expense account provider 250. In this regard, the information in the expense account report 110 may be automatically captured at the expense account provider 250 upon submission of the expense account report 110 by the user. Additionally, the user 200 may able to edit, revise, or copy the expense account report 110 in preparation for submission to the expense account provider 250.

In another embodiment, the expense account report 110 may be provided directly to the expense account provider 250. The expense account provider 250 may be an employer of the user 200 or may have some other relationship that requires the user provide an expense account report to the expense account provider 250. In any regard, the expense account report 110 may be automatically sent directly to the expense account provider 250 or the expense account provider 250 may directly access the expense account report 110. In one embodiment, the automated expense account report generator 100 may directly integrate with an expense account reporting system of the expense account provider 250. Accordingly, the expense account report 110 may automatically be provided directly to the expense account reporting system of the expense account provider 250.

It will be appreciated that the automated expense account generator 110 may comprise appropriate hardware, software, and firmware to accomplish the functionality described above. This may include one or more processors and one or more memories operative to execute machine readable code to provide the foregoing functionality. Each of the merchant interface 140, communication module 130, and automatic expense account report entry generator 130 may include discrete modules in operative communication or may be consolidated into one or more common modules. The functionality of the automated expense account report generator 100 described above may be substantially entirely automated. Accordingly, one or more automatic logic devices may be employed to perform the above noted functionality without the interface of a human user.

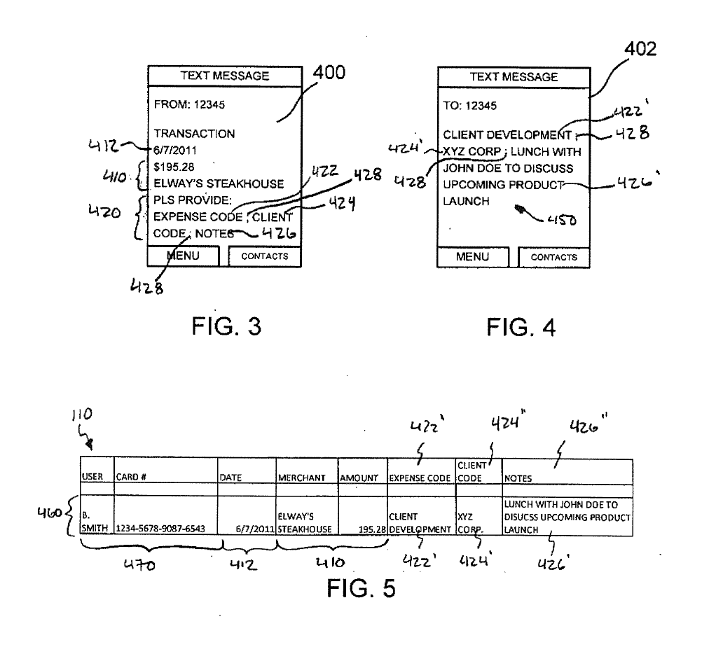

FIGS. 3 and 4 depict embodiments of an automatically generated text message 400 and a response text message 402, respectively. The automatically generated text message 400 shown in FIG. 3 is received by a user in response to initiation of a purchase transaction using a transaction card. The automatically generated text message 400 may include transaction data 410 (e.g., merchant-originated transaction data). The automatically generated text message 400 may also include the date 412 on which the transaction occurred. Additionally, the automatically generated text message 400 may include a request 420 for additional transaction data (i.e., user-originated transaction data). The user-originated transaction data may include any or all of the types of data described above with respect to the user-originated data group.

A non-limiting illustrative example shown in FIG. 3 includes a request for transaction data including a request for expense code data 422, a request for client code data 424 and a request for notes 426. The user may respond to the automatically generated text message 400 with a response text message 402 shown in FIG. 4. The response text message 402 may include user-originated transaction data 450 including expense code data 422′, client code data 424′ and notes 426′. The various portions 422′, 424′ and 426′ of transaction data 450 may be separated or delineated with a delineator such as a delineation character 428 (e.g., a semicolon as shown in FIG. 4). The delineation character 428 may be used in the processing of the response text message 402 by the automatic expense account report entry generator 120 to parse portions of the transaction data 450. Alternatively, separate automatically generated text messages may be sent to the user each requesting each portion of the transaction data 450 in separate response text messages.

FIG. 5 shows a representation of an expense account report 110 including an expense account entry 460 that is automatically generated at least partially based on receipt of the response text message 402 shown in FIG. 4. As shown in FIG. 5, the expense account report 110 is in the form of a spreadsheet, however, it will be understood that the expense account report 110 may take any appropriate form including that of a database or other machine readable data format (e.g., an XML document or the like).

The expense account report entry 460 may include one or more portions of proprietary card data 470. As shown in FIG. 5, the proprietary card data 470 includes a user name and card number. Other pertinent proprietary card data 470 may also be provided in the expense account report entry 460 including, for example, a pin number, login identifier, password, billing address, or other appropriate date. The expense account entry 460 includes the date 412 of the purchase transaction. The expense account entry 460 may also include some or all of the merchant-originated transaction data 410. As shown in FIG. 5, the merchant-originated transaction data 410 may include a merchant identifier and a transaction amount. It will be understood that other appropriate merchant-originated transaction data 410 may also be provided in the expense account report 110.

The expense account entry 460 further includes one or more information fields corresponding to the user-originated transaction data 450 provided in the response text message 402. In this regard, there is an expense code transaction field 422″ populated with the expense code data 422′ provided in the response text message 402. There is also a client code information field 424″ populated with the client code data 424′ provided in the response text message 402. Also, there is a notes information field 426″ populated with the notes data 426′ provided in the response text message 402. In this regard, it will be appreciated that the user-originated transaction data 450 including expense code data 422′, client code data 424′, and notes data 426′ provided in response for text message 402 is automatically populated into appropriate information fields in the expense account report 110.

Additional functionality may also be provided for an automated expense account report generator 100 including providing an inbound messaging number for submission by a user of expense account entries not associated with a transaction using the transaction card. For example, the user 200 may be provided with a number associated with the communication module 130 that accepts inbound text messages. The user may send an inbound text message including expense account entry data (e.g., mileage, tolls, cash expenditures, etc.) for automatic inclusion in the expense account report 110. Such an inbound text message may be of a predetermined format that is parsable by the automatic expense account report entry generator 110 for inclusion in the expense account report 110.

Furthermore, an automatically generated text message may provide an additional security feature for the transaction card as briefly described above. For instance, if a user receives an automatically generated text message for a purchase transaction that was not authorized (e.g., a transaction initiated with a lost or stolen transaction card), the user 200 may respond with a predetermined message in a response text message that alerts the automated expense account report generator 100 of unauthorized use of the transaction card. This notification of unauthorized use may be used to activate fraud protection features of the transaction card.

Additionally, in one embodiment, a user 200 may be able to indicate that an expense was a personal expense. For instance, in response to an automatically generated text message, the user 200 may respond with an appropriate indicator (e.g., “PERSONAL”) to indicate the purchase transaction that is the subject of the automatically generated text message should not be included in the expense account report. Accordingly, if the user 200 is reimbursed for their expenses, purchase transactions indicated as personal transactions may be excluded from the expense account report and the reimbursement payment. In a situation where the expense account provider automatically pays the balance for the transaction card, purchase transactions indicated as personal transactions may be treated as an advance to the employee or reconciled in another appropriate accounting manner by the expense account provider.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain known modes of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

1. A method for automatic generation of an expense account report, comprising:
detecting the occurrence of a purchase transaction initiated using a transaction card by a user;
initiating transmission of at least one automatically generated text message to a mobile device associated with said user, wherein said automatically generated text message comprises a request for transaction data corresponding to said purchase transaction;
receiving a response text message initiated at said mobile device in response to said automatically generated text message including said transaction data; and
processing said response text message to automatically generate an expense account entry of an expense account report, wherein said expense account entry includes said transaction data.

2. A method according to claim 1, wherein said detecting, initiating, receiving, and processing are performed automatically using one or more automated logic devices.

3. A method according to claim 2, wherein said expense account report includes a plurality of expense account entries corresponding to respective purchase transactions initiated using said transaction card during a predetermined time period.

4. A method according to claim 3, wherein said expense account report includes an expense account entry corresponding to each purchase transaction initiated using said transaction card during said predetermined time period.

5. A method according to claim 3, wherein said expense account report is maintained in a computer readable medium for review by a user.

6. A method according to claim 5, further comprising:
providing access to said expense account report by said user.

7. A method according to claim 6, wherein said access requires providing proprietary card data associated with said transaction card.

8. A method according to claim 7, wherein said proprietary card data comprises data selected from the group consisting of: a user name, a password, a personal identification number, a card number, and a billing address.

9. A method according to claim 6, further comprising:
transmitting said expense account report to said user.

10. A method according to claim 9, wherein said expense account report is sent to said user with a billing statement, wherein said predetermined time period coincides with said billing statement period.

11. A method according to claim 5, further comprising:
transmitting said expense account report directly to an expense account provider.

12. A method according to claim 1, wherein said transaction data comprises data selected from the group consisting of: third party identification data, customer identification data, client identification data, expense code data, notes, project identification data, and accounting data.

13. A method according to claim 12, wherein said transaction data corresponds to at least one predetermined information field of said expense account entry.

14. A method according to claim 13, wherein said transaction data corresponds to a plurality of predetermined information fields of said expense account entry, and wherein transaction data corresponding to different respective ones of said predetermined information fields is separated by a delineator.

15. A method according to claim 1, further comprising:
processing said purchase transaction.

16. A method according to claim 15, wherein said automatically generated text message includes at least a portion of merchant-originated transaction data used for said processing.

17. A system for automatic generation of an expense report, comprising:
a merchant interface module operable to detect a purchase transaction initiated by a user using a transaction card;
a communication module in operative communication with said merchant interface module that is operable to initiate transmission of an automatically generated text message to a mobile device associated with said user in response to said purchase transaction, said communication module further operable to receive a response text message including transaction data corresponding to said purchase transaction initiated at said mobile device in response to said automatically generated text message;
an automatic expense account report entry generator in operative communication with said communication module that is operable to process said response text message and automatically generate an expense account report entry including at least a portion of said transaction data; and
an expense account report including said expense account report entry.

18. (canceled)

19. A system according to claim 17, wherein said merchant interface module receives at least a portion of merchant-originated transaction data provided for processing said purchase transaction by a financial institution.

20.-28. (canceled)

29. A system according to claim 17, wherein said expense account report is maintained in a computer readable medium for review by said user.

30.-34. (canceled)

35. A system according to claim 17, wherein said communication module is operable to receive a response text message in response to said automatically generated text message indicating said purchase transaction is unauthorized.

36. (canceled)
